(19) United States
(12) Patent Application Publication
(10) Pub. No.: US 2018/0206421 A1
(43) Pub. Date: Jul. 26, 2018

(54) SEGREGATED HYDROPONIC ASSEMBLY

(71) Applicant: JAK Projects, LLC, Grants Pass, OR (US)

(72) Inventors: Joshua M. Scott, Grants Pass, OR (US); Aimee Jeannette Jacobsen, Idleyld Park, OR (US); Kelley James Davis, Idleyld Park, OR (US)

(73) Assignee: JAK Projects, LLC, Grants Pass, OR (US)

(21) Appl. No.: 15/649,045

(22) Filed: Jul. 13, 2017

Related U.S. Application Data
(60) Provisional application No. 62/450,230, filed on Jan. 25, 2017.

(51) Int. Cl. A01G 31/02

(52) U.S. Cl. CPC A01G 31/02

(57) ABSTRACT

An all in one segregated hydroponic assembly plants to be grown in a fluid nutrient that is segregated and sealed in a reservoir, where the fluid is controllably applied on a plant housing that supports plant growth. A reservoir contains the fluid nutrient. The reservoir has a sloped base panel to enable discharge excess of fluid. A plant housing provides a floor for supporting hydroponic plant growth. The plant housing is disposed in a spaced-apart, coplanar relationship with the reservoir to seal the fluid nutrient in the reservoir and protect fluid nutrient from contamination and evaporation. The floor of plant housing has a square-shaped geometric pattern that forms groove to enhance flow of fluid, aeration, and provides space for roots to expand.

### CROSS REFERENCE OF RELATED APPLICATIONS

This application claims the benefits of U.S. provisional application No. 62/450,230, filed Jan. 25, 2017 and entitled SEALED HYDROPONIC ASSEMBLY WITH MOBILE CAPACITY, which provisional application is incorporated by reference herein in its entirety.

### FIELD OF THE INVENTION

The present invention relates generally to a segregated hydroponic assembly. More so, the present invention relates to a hydroponic assembly enables growing plants in a fluid nutrient environment that is segregated and sealed in a reservoir, where the fluid is controllably applied on a plant housing that supports the plant growth; whereby the fluid reservoir is sloped for efficient distribution and discharge of the fluid nutrient; whereby the plant housing is disposed in a spaced-apart, coplanar relationship with the reservoir to seal the fluid nutrient in the reservoir and protect fluid nutrient from contamination and evaporation; whereby the floor of plant housing has a square-shaped geometric pattern that forms groove to enhance flow of fluid, aeration, and provides roots space for roots to expand.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, hydroponic growth is the process of growing plants in a liquid or fluid nutrient environment without the use of soil or an aggregate medium. Often, hydroponics involves a process of cultivating plants without the use of soil, with the soil replaced by a medium such as gravel, coconut husk or even mineral wool. The only requirements for the vegetation are air, sunlight, nutrients, water, and a medium which the roots can grow into to support the plant.

In operation, hydroponic growth is accomplished by suspending a plant's roots through a support medium into a closed environment wherein nutrients and other sustenance, e.g., a nutrient rich water solution, for the plant are flooded onto the dangling roots while the leaves and crown of the plant extend upwardly from the support-medium.

It is known in the art that growing plants using hydroponic methods can be advantageous, particularly in areas where ground soil is contaminated or not conducive to plant life. Further, hydroponics can be implemented indoors in areas where the natural climate does not allow for normal plant production. Without the use of soil, plants that are grown hydroponically can take up a fraction of the space associated with plants grown in fields, gardens and beds and because no soil is involved.

The fluid nutrient used to feed the plant can, however, often evaporate if not refilled into a reservoir regularly. Also, chemical toxins and other impurities can contaminate the fluid nutrient. Another problem with hydroponic growth is that excess fluid nutrient can accumulate and oversaturate the plant if not discharged in a timely manner.

Other proposals have involved hydronic systems. The problem with these hydronic systems is that they do not sufficiently protect the fluid nutrient and provide a means for discharge of excess fluid nutrient. Also, uniform distribution of the fluid nutrient on the plant can be problematic. Also, the roots do not always have sufficient room to grow. Even though the above cited hydronic systems meet some of the needs of the market, a segregated hydroponic assembly that enables growing plants in a fluid nutrient environment that is segregated and sealed in a reservoir, where the fluid is controllably applied on a plant housing that supports the plant growth is still desired.

### SUMMARY

Illustrative embodiments of the disclosure are generally directed to a segregated hydroponic assembly for controlled hydroponic growth of a plant. The segregated hydroponic assembly enables growing plants in a fluid nutrient environment that is segregated and sealed in a reservoir with a plant housing. The sealed reservoir protects the fluid nutrient from contamination and evaporation. A plant housing supports the plant in hydroponic growth. The plant housing seals the reservoir. The plant housing is defined by a geometric pattern that allows room for the roots and free flow of fluid nutrient. The fluid nutrient is carried from the reservoir and controllably applied onto a plant housing that supports a plant for growth.

In some embodiments, a reservoir stores and protects the fluid nutrient in a sealed environment. The reservoir is defined by a base panel and sidewalls that form a reservoir cavity containing a fluid nutrient. The base panel is sloped for efficient distribution and discharge of the fluid nutrient through a discharge opening on the lower end of the reservoir.

A plant housing is configured to support hydroponic plant growth. The plant housing is disposed in a spaced-apart, coplanar relationship with the reservoir, so as to seal the fluid nutrient in the reservoir cavity and protect the fluid nutrient from contamination and evaporation. In one embodiment, the floor of the plant housing has a square-shaped geometric pattern that forms groove to enhance flow of fluid, aeration, and provide roots space for expansion.

In one alternative embodiment, a pump area may be used to support and house a pump that forces the fluid nutrient into the plant housing. The cross pipes also connect the pipes and work with the pipes to support tall plants and heavy flowers and buds.

In one aspect, a segregated hydroponic assembly, comprises:
a reservoir defined by a base panel and a sidewall that form a reservoir cavity, the reservoir further defined by a first end, a second end, and at least one discharge opening forming at the second end, the base panel being sloped down towards the discharge opening;
at least one mobile portion configured to join with the reservoir, the at least one mobile portion configured to enable movement of the assembly;
a plant housing comprising a generally flat floor defined by a periphery and a geometric pattern, the geometric pattern of the floor having a series of square-shaped protrusions that form a plurality of grooves, the plant housing configured to position in a generally coplanar, spaced-apart relationship with the base panel of the reservoir, the plant housing further configured to at least partially form a seal in the reservoir cavity of the reservoir;
at least one reinforcement bar disposed to traverse the floor of the plant housing;
a plurality of pipes defined by a plurality of apertures, a reservoir end, an elevated end, and an elongated pipe cavity, the plurality of pipes disposed to extend from the periphery of the floor of the plant housing in a spaced-apart, parallel arrangement;
a plurality of cross pipes defined by a pair of free ends, the plurality of cross pipes disposed to traverse the plant housing, the plurality of cross pipes configured to join the plurality of pipes, whereby the pair of free ends of the plurality of cross pipes detachably join with the elevated end of the plurality of pipes;
at least one pipe connector configured to fasten the reservoir end of the plurality of pipes to the pair of free ends of the plurality of crossbars; and
a pump area configured to support and house a pump, the pump configured to force the fluid nutrient from the reservoir cavity into the plant housing.

In another aspect, the periphery of the floor is flanged.

In another aspect, the plurality of pipes and the plurality of cross pipes comprise a ¾ inch polyvinyl chloride pipe.

In another aspect, the plurality of pipes are disposed vertically above the plant housing.

In another aspect, the plurality of cross pipes are disposed horizontally above the plant housing.

In another aspect, the at least one mobile portion comprises a wheel and axle.

In another aspect, the reservoir cavity contains a fluid nutrient.

In another aspect, the plant housing supports growth of a plant.

One objective of the present invention is to provide an improved assembly that propagates plant and vegetation growth under hydroponic conditions through uniform exposure to nutrients, moisture, and lights.

Another objective is to provide a plant housing that sealably mates with the reservoir, such that the fluid nutrient in the reservoir is segregated from the plant growing on the plant housing, so as to minimize contamination and evaporation of the fluid nutrient.

Another objective is to enhance aeration in the roots with a square-shaped geometric pattern on the plant housing.

Another objective is to facilitate drainage of excess fluid nutrient by tilting the base panel of the reservoir.

Another objective is to provide pipes and cross pipes for hanging the upper region of tall plants and heavier fruits and buds as needed.

Another objective is to facilitate mobility of the hydroponic assembly with at least one mobile portion.

Yet another objective is to save a substantial cost in fluid nutrients by using the sealed arrangement between the reservoir and the plant housing, so as to minimize evaporation and contamination of the fluid.

Yet another objective is to expand the volume of plant growth, while optimizing the quantity of plants and vegetation that can be grown.

Yet another objective is to provide a hydroponic assembly that is adaptable both to commercial greenhouse and domestic home use conditions.

Yet another objective is to provide a hydroponic assembly that produces a healthier plant using less space than currently applied techniques.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary segregated hydroponic assembly, in accordance with an embodiment of the present invention;

FIG. 2 illustrates a top view of an exemplary reservoir, in accordance with an embodiment of the present invention;

FIG. 3 illustrates an elevated side view of the reservoir, showing the sloped base panel, in accordance with an embodiment of the present invention;

FIG. 4 illustrates a perspective view of the hydroponic assembly shown in FIG. 1 with exemplary pipes disassembled, in accordance with an embodiment of the present invention;

FIG. 5 illustrates a top view of an exemplary plant housing, in accordance with an embodiment of the present invention;

FIG. 6 illustrates an elevated side view of a segregated hydroponic assembly, in accordance with an embodiment of the present invention;

FIG. 7 illustrates a bottom view of a plant housing, in accordance with an embodiment of the present invention; and

FIG. 8 illustrates a perspective view of pipes and cross pipes attached across the plant housing, in accordance with an embodiment of the present invention.

Like reference numerals refer to like parts throughout the various views of the drawings.

### DETAILED DESCRIPTION OF THE INVENTION

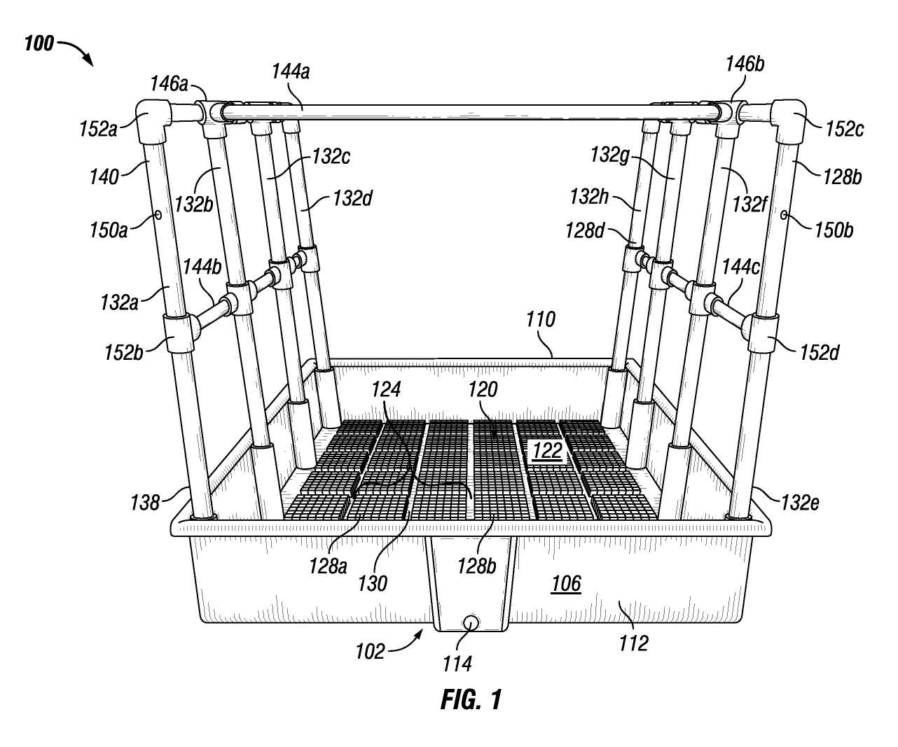

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A segregated hydroponic assembly 100 is referenced in FIGS. 1-8. The segregated hydroponic assembly 100, hereafter “assembly 100” enables controlled hydroponic growth of a plant, while protecting a fluid nutrient, which feeds the plant, from evaporation and contamination inside a sealed reservoir 102. A plant housing 120 supports the plant in hydroponic growth. The plant housing 120 engages the reservoir, so as to cover the reservoir 102 and thereby seal the fluid nutrient in the reservoir 102. The plant housing 120 has a floor 122 that is defined by a geometric pattern 124 that allows room for the roots of the plant to grow, allows for the free flow of fluid nutrient.

A plurality of pipes 132a-h and cross pipes 144a-f serve to interconnect the pipes 132a-h. The pipes 132a-h and cross pipes 144a-f provide a surface for the plant, and especially tall or heavy plants, to grow.

As referenced in FIG. 1, the assembly 100, comprises a reservoir 102 that stores and protects the fluid nutrient in a sealed environment. The reservoir 102 is configured to contain a volume of the fluid nutrient necessary for plant growth. The reservoir 102 is also configured to enable uniform, drip distribution of the fluid nutrient to a plant housing 120 that supports the plant for hydroponic growth. The reservoir 102 is unique in that the fluid nutrient is substantially sealed into the reservoir 102, so as to minimize evaporation and contamination from external environment and to couple with the plant housing 120 as an all in one hydroponics system thereby saving space in the hydroponics room.

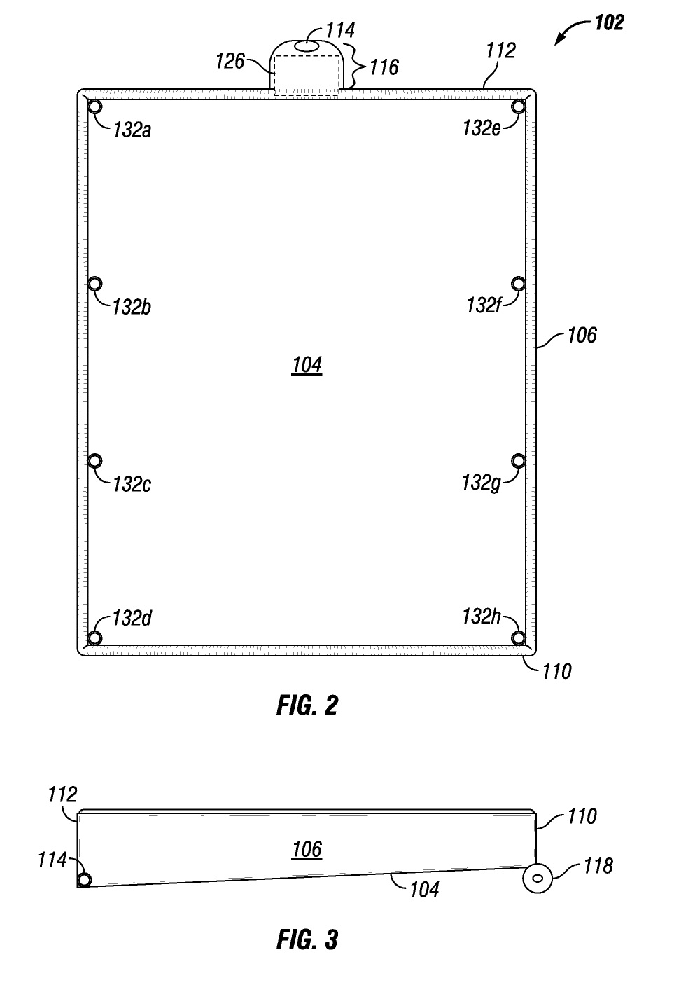

Looking now at FIG. 2, the reservoir 102 is defined by a base panel 104 and a sidewall 106 that form a reservoir cavity 108 that contains the fluid nutrient. The reservoir 102 is further defined by a first end 110, a second end 112, and at least one discharge opening 114 forming at the second end 112. In one embodiment, the reservoir 102 has a generally rectangular, voluminous dimension. In one embodiment, the reservoir 102 has a width of 40″, a length of 77″, and a depth of 20″. Suitable materials for the reservoir 102 may include, without limitation, polyurethane, polyethylene, polyvinyl chloride, a rigid polymer, aluminum, metal alloys, and fiberglass. The reservoir also contains a pump area 116 for a sump pump (not shown) to go into without having to raise the entire plant housing 120, this makes for easy draining and changing of nutrients.

In some embodiments, the reservoir cavity 108 in the reservoir 102 may be sized to contain any quantity of fluid nutrients, so as to enable efficient growth of the plant. The discharge opening 114 in the second end 112 of the reservoir 102 may utilize a plug that selectively covers the opening 114 to enable regulated discharge of excess fluid nutrient. The fluid nutrients may include, without limitation, an aqueous nutrient solution or a fluid containing at least one of the following: water, Nitrogen, Potassium, Phosphorous, Calcium, Magnesium, Sulphur, Iron, Manganese, Copper, Zinc, Molybdenum, Boron, and Chlorine.

As the sectioned view of FIG. 3 illustrates, the base panel 104 is sloped down towards the discharge opening 114 at the second end 112 of the reservoir 102. The base panel 104 is sloped in this manner to enable the efficient distribution and discharge of the fluid nutrient through the discharge opening 114 or sump pump (not shown) on the second, or lower, end 112 of the reservoir 102. In this manner, the fluid nutrient can drain from the discharge opening 114 when the plug is removed for emptying the reservoir cavity 108 and changing nutrients.

In some embodiments, the assembly 100 may include at least one mobile portion 118 configured to join with the reservoir 102. The mobile portion 118 is configured to enable movement of the assembly 100, and may include rolling or sledding means that enable a single person to easily move the assembly 100. In one embodiment, the mobile portion 118 comprises a wheel and axle. In an alternative embodiment, a handle may be used to grip the assembly 100 to actuate the mobile portion 118.

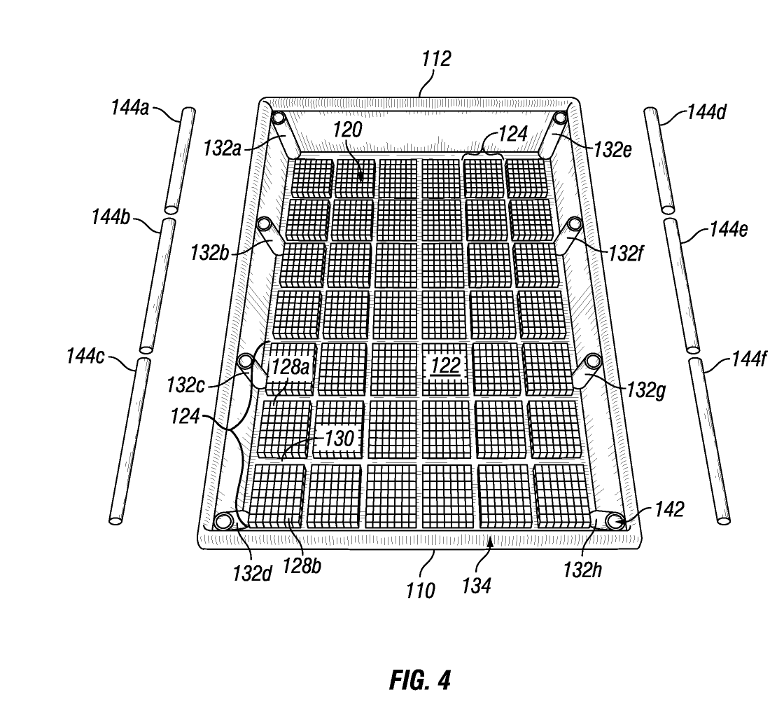

As shown in FIG. 4, the assembly 100 may include a plant housing 120 to provide the hydroponic environment for the plant to grow in. In some embodiments, the plant housing 120 support plants, and especially the lower root region of plants for growth. The plant housing 120 is disposed in a spaced-apart, coplanar relationship with the reservoir 102, so as to at least partially seal the fluid nutrient in the reservoir cavity 108 and protect the fluid nutrient from contamination and evaporation.

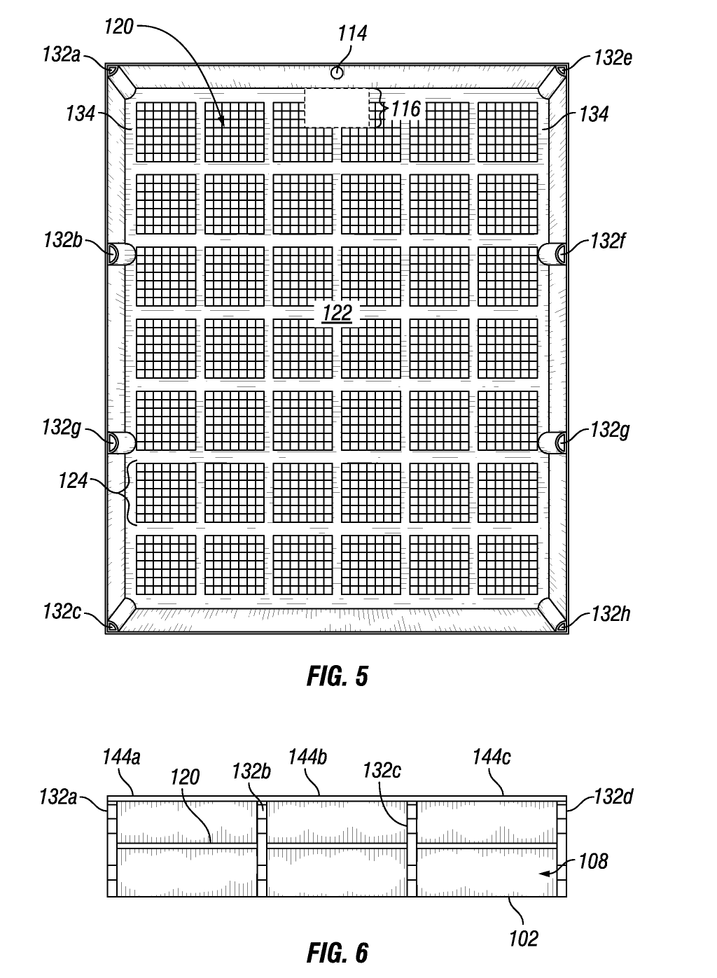

As FIG. 5 illustrates, the plant housing 120 includes a generally square pattern floor 122. In one embodiment, the floor 122 is substantially the same perimeter size as the reservoir 102. In some embodiments, the floor 122 may be rectangular, circular, or square in shape. The plant housing 120 is also defined by a periphery 134. In one embodiment, the periphery 134 is flanged and has a rounded lip.

The dimensions of the floor 122 allow the plant housing 120 to overlay the reservoir 102 in a generally flush, coplanar relationship, where the periphery 134 of the plant housing 120 forms a snug relationship with the sidewall 106 of the reservoir 102. This engagement works to at least partially seal the fluid nutrient in the reservoir cavity 108, as the sectioned side view of FIG. 6 shows. Thus, the plant housing 120 mates with the reservoir 102, such that the fluid nutrient in the reservoir 102 is segregated from the plant growing on the plant housing 120, so as to minimize contamination and evaporation of the fluid nutrient.

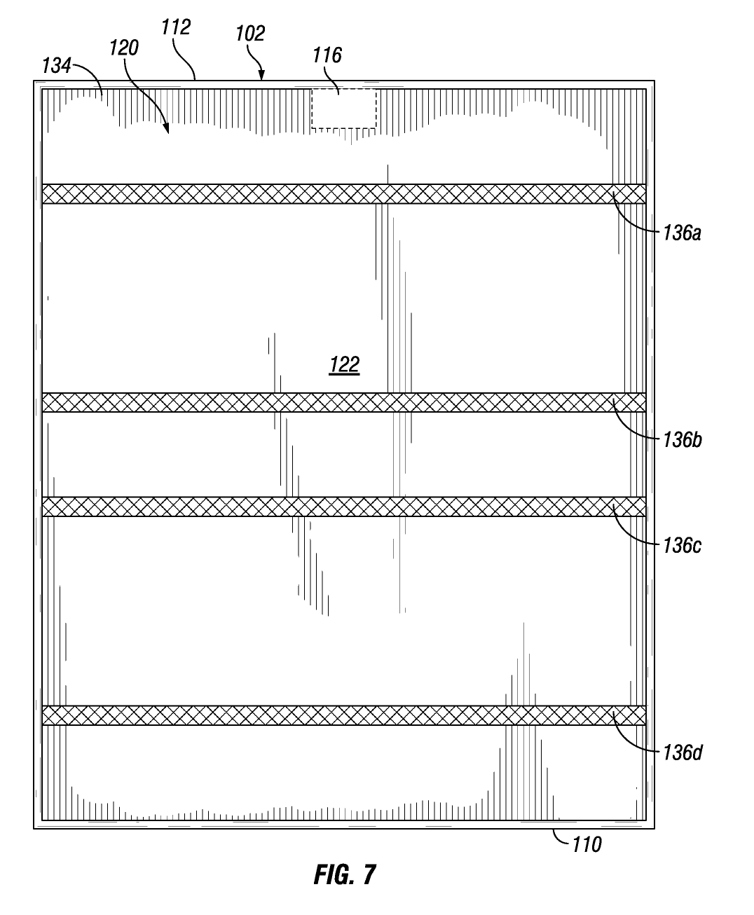

As FIG. 7 shows, the floor 122 of the plant housing 120 may be reinforced with at least one reinforcement bar 136a-c. The reinforcement bar 136a-c may be disposed to traverse the floor 122 of the plant housing 120, and provide structural integrity to the plant housing 120. In one embodiment, three spaced-apart bars disposed coplanar with the floor 122 of the plant housing 120 may be used as reinforcement bars 136a-c.

The plant housing 120 comprises a generally flat floor 122 that is defined by a periphery 134 and a square-shaped geometric pattern 124. In this configuration, the periphery 134 may include a flange that is about 7″ high and include a rounded lip with a 1″ diameter. The geometric pattern 124 of the floor 122 may include a series of square-shaped protrusions 128a, 128b that form a plurality of grooves 130. In one embodiment, the square-shaped geometric pattern 124 forms a plurality of grooves 130 that enhance flow of fluid, aeration, while also providing space for the roots to freely expand during growth.

Turning back to FIG. 4, the plant housing 120 comprises a floor 122 that is defined by a square-shaped geometric pattern 124 on which at least a portion of the plant medium rests. The geometric pattern 124 is configured to allow more space for plant roots to grow and enhances airflow and drainage. The geometric pattern 124 of the plant housing 120 comprises a series of square-shaped protrusions 128a, 128b.

In one exemplary growing method, the roots of the plant can be positioned along grooves 130 between individual square shaped protrusions 128a.

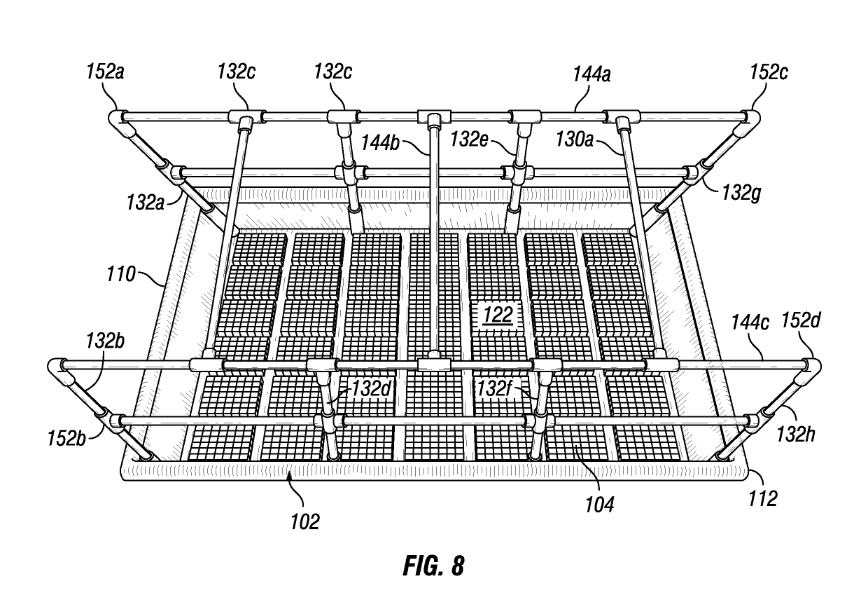

As FIG. 8 illustrates, the assembly 100 may include a plurality of pipes 132a-h. The pipes 132a-h are defined by a plurality of apertures 150a, 150b, a reservoir end 138, an elevated end 140, and an elongated pipe cavity 142. The reservoir end 138 is oriented towards the plant housing 120, while the elevated end 140 is disposed outwardly from the plant housing 120. In one embodiment, the pipes 132a-h extend vertically out from the periphery 134 of the floor 122 of the plant housing 120 in a spaced-apart, parallel arrangement. In one embodiment, the pipes 132a-h are vertical and perpendicular to the plant housing 120 . . . .

In one embodiment, the pipes 132a-h comprise eight ¾″ polyvinyl chloride pipe (PVC) pipes. The vertical pipes 132h extend from plant housing 102, while the horizontal cross pipes 144a-f extend between the elevated end 140 of the vertical pipes 132a-h. In one exemplary use of the pipes 132a-h in this adaptation, eight PVC vertical pipes couple to the plant housing 120, such that the PVC pipes are vertical and tower over the plant housing 120

Looking again at FIG. 8, the assembly 100 provides a plurality of cross pipes 144a-f that traverse the plant housing 120 while detachably joining the pipes 132a-h. The cross pipes 144a-f are defined by a pair of free ends 146a, 146b. The cross pipes 144a-f horizontally traverse the plant housing 120, and are configured to join the elevated end of the pipes 132a-h. In this manner, the pair of free ends of the plurality of cross pipes 144a-f detachably join with the elevated end of the plurality of pipes 132a-h.

In some embodiments, a pump area 116 forms a part of the reservoir 102. The pump area 116 may be used to support and house a pump. If a pump is, indeed used, the pump may be configured to force the fluid nutrient from the reservoir cavity 108 and through the pipe cavity 142 of the pipes 132a-h, and the cross pipes 144a-f. A lid 126 covers the pump area 116. The lid may be sealed, or opened through a hinge or a sliding rail mechanism. In this manner, a user may add and remove a pump by lifting the lid. In some embodiments, the pump may include a removable sump pump or other basic electrical pumping mechanism known in the art. The pump area 116 provides necessary dimensions to operate a pump that serves to force the liquid through the reservoir 102 into the plant housing 120.

In some embodiments, the assembly 100 may include at least one pipe connector 152a-d configured to fasten the reservoir end 138 of the plurality of pipes 132a-h to the pair of free ends 146a, 146b of the cross pipes 144a-f. In one embodiment, a set of horizontally displaced cross pipes 144a-f, such as PVC pipes, can be coupled to the vertical pipes 132a-h through at least one pipe connector 152a-d, i.e., T-couple, L-couple. In this manner, the horizontal cross pipes 144a-f are fastened between the pairs of vertical pipes 132a-h in multiple combinations and adjustable lengths. This can be advantageous when adjusting to the growth of the plants.

In one exemplary use, the cross pipes 144a-f connect the pipes 132a-h and work with the pipes 132a-h to support tall plants and heavy flowers and buds. The cross pipes 144a-f and pipes 132a-h serve to allow tall plants, large fruits, and buds to be easily hung for optimizing space and growth capacity of the plant. The height of the pipes 132a-h and the length of the cross pipes 144a-f are scalable to adjust in correlation with the growth of the plant.

For example, an upper region of the plant can be hung on the overlying cross pipe 144a while a lower, root region of the plant remains at least partially submerged on the floor 122 of the plant housing 120. This allows the plant to have more space to grow, and greater exposure to sunlight, air flow, and moisture in the air. As the plant grows, the upper region of the plant may be tied to the horizontal or vertical PVC pipes to provide greater space and access to nutrients, sunlight, and air flow for the plant.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An all in one hydroponic assembly, the assembly comprising:
a reservoir defined by a base panel and a sidewall that form a reservoir cavity, the reservoir further defined by a first end, a second end, and at least one discharge opening forming at the second end, the base panel being sloped down towards the discharge opening;
at least one mobile portion configured to join with the reservoir, the at least one mobile portion configured to enable movement of the assembly;
a plant housing comprising a generally flat floor defined by a periphery and a geometric pattern, the plant housing configured to position in a generally coplanar, spaced-apart relationship with the base panel of the reservoir, the plant housing further configured to at least partially form a seal in the reservoir cavity of the reservoir;
at least one reinforcement bar disposed to traverse the floor of the plant housing;
a plurality of pipes defined by a plurality of apertures, a reservoir end, an elevated end, and an elongated pipe cavity, the plurality of pipes disposed to extend from the periphery of the floor of the plant housing in a spaced-apart, parallel arrangement; and
a plurality of cross pipes defined by a plurality of cross apertures and a pair of free ends, the plurality of cross pipes disposed to traverse the plant housing, the plurality of cross pipes configured to join the plurality of pipes, whereby the pair of free ends of the plurality of cross pipes detachably join with the elevated end of the plurality of pipes.

2. The assembly of claim 1, wherein the geometric pattern of the floor of the plant housing comprises a series of square-shaped protrusions that form a plurality of grooves.

3. The assembly of claim 1, wherein the periphery of the floor is flanged.

4. The assembly of claim 1, wherein the plurality of pipes and the plurality of cross pipes comprise a ¾ inch polyvinyl chloride pipe.

5. The assembly of claim 1, wherein the plurality of pipes are disposed vertically above the plant housing and the reservoir.

6. The assembly of claim 1, wherein the plurality of cross pipes are disposed horizontally above the plant housing and the reservoir.

7. The assembly of claim 1, wherein the at least one mobile portion comprises a wheel and axle.

8. The assembly of claim 1, further comprising at least one pipe connector configured to fasten the reservoir end of the plurality of pipes to the pair of free ends of the plurality of crossbars.

9. The assembly of claim 1, further comprising a pump area.

10. The assembly of claim 1, further comprising a lid configured to regulate access to the pump area.

11. A hydroponic assembly, the assembly comprising:
a reservoir defined by a base panel and a sidewall that form a reservoir cavity, the reservoir further defined by a first end, a second end, and at least one discharge opening forming at the second end, the base panel being sloped down towards the discharge opening;
at least one mobile portion configured to join with the reservoir, the at least one mobile portion configured to enable movement of the assembly;
a plant housing comprising a generally flat floor defined by a periphery and a geometric pattern, the geometric pattern of the floor having a series of square-shaped protrusions that form a plurality of grooves, the plant housing configured to position in a generally coplanar, spaced-apart relationship with the base panel of the reservoir, the plant housing further configured to at least partially form a seal in the reservoir cavity of the reservoir;
at least one reinforcement bar disposed to traverse the floor of the plant housing;
a plurality of pipes defined by a plurality of apertures, a reservoir end, an elevated end, and an elongated pipe cavity, the plurality of pipes disposed to extend from the periphery of the floor of the plant housing in a spaced-apart, parallel arrangement;
a plurality of cross pipes defined by a plurality of cross apertures and a pair of free ends, the plurality of cross pipes disposed to traverse the plant housing, the plurality of cross pipes configured to join the plurality of pipes, whereby the pair of free ends of the plurality of cross pipes detachably join with the elevated end of the plurality of pipes;
at least one pipe connector configured to fasten the reservoir end of the plurality of pipes to the pair of free ends of the plurality of crossbars;
a pump area disposed in the reservoir; and
a lid configured to regulate access to the pump area.

12. The assembly of claim 11, wherein the periphery of the floor is flanged.

13. The assembly of claim 11, wherein the plurality of pipes and the plurality of cross pipes comprise a ¾ inch polyvinyl chloride pipe.

14. The assembly of claim 11, wherein the plurality of pipes are disposed vertically above the plant housing and the reservoir.

15. The assembly of claim 11, wherein the plurality of cross pipes are disposed horizontally above the plant housing and the reservoir.

16. The assembly of claim 11, wherein the at least one mobile portion comprises a wheel and axle.

17. The assembly of claim 11, wherein the reservoir cavity contains a fluid nutrient.

18. The assembly of claim 18, wherein the plant housing supports growth of a plant.

19. A hydroponic assembly, the assembly consisting of:
a reservoir defined by a base panel and a sidewall that form a reservoir cavity, the reservoir cavity configured to contain a fluid nutrient, the reservoir further defined by a first end, a second end, and at least one discharge opening forming at the second end, the base panel being sloped down towards the discharge opening;
a wheel and axle configured to join with the reservoir, the wheel and axle configured to enable movement of the assembly;
a plant housing configured to support growth of a plant, the plant housing comprising a generally flat floor defined by a periphery and a geometric pattern, the geometric pattern of the floor having a series of square-shaped protrusions that form a plurality of grooves, the plant housing configured to position in a generally coplanar, spaced-apart relationship with the base panel of the reservoir, the plant housing further configured to at least partially form a seal in the reservoir cavity of the reservoir;
at least one reinforcement bar disposed to traverse the floor of the plant housing;
a plurality of pipes defined by a plurality of apertures, a reservoir end, an elevated end, and an elongated pipe cavity, the plurality of pipes disposed to extend from the periphery of the floor of the plant housing in a spaced-apart, parallel arrangement, the plurality of pipes including a ¾ inch polyvinyl chloride pipe;
a plurality of cross pipes defined by a plurality of cross apertures and a pair of free ends, the plurality of cross pipes disposed to traverse the plant housing, the plurality of cross pipes configured to join the plurality of pipes, whereby the pair of free ends of the plurality of cross pipes detachably join with the elevated end of the plurality of pipes;
at least one pipe connector configured to fasten the reservoir end of the plurality of pipes to the pair of free ends of the plurality of crossbars;
a pump area disposed in the reservoir; and
a lid configured to regulate access to the pump area.
